(19) United States
(12) Patent Application Publication
(10) Pub. No.: US 2012/0106764 A1
(43) Pub. Date: May 3, 2012

(54) Multi-Function Mobile Device Carrying Case

(75) Inventor: Bradley A. Burns, Kapaa, HI (US)

(73) Assignee: GoMango, LLC, Kapaa, HI (US)

(21) Appl. No.: 13/253,910

(22) Filed: Oct. 5, 2011

Related U.S. Application Data
(60) Provisional application No. 61/407,141, filed on Oct. 27, 2010.

(51) Int. Cl. H04R 1/02

(52) U.S. Cl. 381/334

(57) ABSTRACT

A multi-function mobile device carrying case for a mobile device includes a case housing incorporating a retractable headset, a microphone, a multi-function control button, and an interface cable. The carry case further includes a device housing attached to the case housing and configured to accommodate a mobile device. When a mobile device is placed in the device housing and the interface cable is connected into the headphone jack of the mobile device, the carrying case enables the user to use various functions of the mobile device without accessing the mobile device itself.

### CROSS-REFERENCE TO RELATED APPLICATIONS

This application claims the benefit of U.S. Provisional Patent Application Ser. No. 61/407,141, filed on Oct. 27, 2010, which application is incorporated herein by reference in its entirety.

### FIELD OF THE INVENTION

The invention relates to a mobile device carrying case and, in particular, to a mobile device carrying case providing headset, microphone and user control functionalities.

### DESCRIPTION OF THE RELATED ART

Mobile phone carrying cases for housing mobile phones are known. U.S. Patent Publication No. US 2001/0035242 to Hughs et al. describes a mobile phone carrying case including a retractable headset device installed in an integral pocket. Other mobile phone carrying cases, such as cases with sound enhancing capability (U.S. Pat. Pub. 2010/0206923) or with an integrated input-output device (U.S. Pat. Pub. 2008/0108387), have been described.

### SUMMARY OF THE INVENTION

According to one embodiment of the present invention, a mobile device carrying case includes a case housing including a retractable headset, a microphone, a control button and an interface cable integrated therein; and a device housing attached to the case housing and configured to accommodate a mobile device. The interface cable is electrically connected to the retractable headset, the microphone, the control button and the interface cable is to be electrically connected to a headphone jack of a mobile device to be housed in the device housing. As thus configured, the carrying case provides audio, microphone and control functions for the mobile device through the interface cable.

The present invention is better understood upon consideration of the detailed description below and the accompanying drawings.

### BRIEF DESCRIPTION OF THE DRAWINGS

FIG. 1 is a perspective view of a multi-function mobile device carrying case according to one embodiment of the present invention.

FIG. 2 is an exploded view of the multi-function mobile device carrying case showing the internal construction of the carrying case according to one embodiment of the present invention.

### DETAILED DESCRIPTION OF THE PREFERRED EMBODIMENTS

In accordance with the principles of the present invention, a multi-function mobile device carrying case (“carrying case”) for a mobile device includes a case housing incorporating a retractable headset, a microphone, a multi-function control button, and an interface cable. The carry case further includes a device housing formed on a front side of the case housing for accommodating a mobile device. When a mobile device is placed in the device housing and the interface cable is connected into the headphone jack of the mobile device, the carrying case enables the user to use various functions of the mobile device without accessing the mobile device itself.

In some embodiments, the multi-function mobile device carrying case enables the user to answer incoming calls using the retractable headset, the microphone, and the control button of the carrying case. The carrying case of the present invention enables the user to utilize the mobile phone function of the mobile device in a hands-free manner. The user may also utilize the voice control capability of the mobile device, if any, through the control button and the microphone of the carrying case. Furthermore, when the mobile device incorporates an audio player function for music or audio books, the control button of the carrying case of the present invention may be used to control the audio player, such as to change songs or fast forward to a different song or skip forward to a different chapter of the audio book. The user may access music or e-books on his mobile device without accessing or touching the mobile device. In one embodiment, the retractable headset is a stereo headset to allow the user to enjoy music or audio books in stereo sound.

In one embodiment, the mobile device is an iPhone, available from Apple Inc., Cupertino, Calif. The interface cable is plugged into the 3.5 mm stereo headphone minijack on the iPhone device. The multi-function mobile device carrying case can be used for answering incoming telephone calls, placing outgoing telephone calls using voice control, and also for controlling the iPod music player. More specifically, the control button of the carry case of the present invention is configured to activate the voice control function of the iPhone device. By enabling the use of the voice control function of the iPhone, the carrying case of the present invention realizes hands-free operation for placing outgoing telephone calls.

In embodiments of the present invention, the multi-function mobile device carrying case can be configured to operate with a variety of mobile devices including wireless mobile phones, also known as cellular phones, smart phones, personal audio players or other mobile personal devices. In some embodiments, the multi-function mobile device carrying case of the present invention can be configured to operate with the iPhone from Apple, Inc., the Android mobile phones from Google, Inc., the Blackberry mobile phones from Research In Motion Limited, and other Windows based mobile devices. In other embodiments, the multi-function mobile device carrying case of the present invention can be configured to operate with the iPod from Apple, Inc., the Microsoft Zune and other personal audio devices.

The multi-function mobile device carrying case of the present invention provides many advantages over conventional carrying cases. First, the carrying case enables a user to operate the phone functions of the mobile device without having to reach, access or even touch the mobile phone. The carrying case allows the user to realize hands-free operation of the mobile device. Second, a user may quickly answer an incoming call by pulling out the retractable headset and pushing the control button. The user does not have to fumble with tangled headset cable because the headset is stored in a retractable manner, to allow it to be easily extended and automatically retracted for smooth operation. That is, the headset does not become entangled and the user can quickly access the headset.

Third, by using the headset and the microphone of the carrying case to answer telephone calls, the high frequency transmitter of the mobile device is kept away from the user's head. Placing high frequency transmitters (such as a mobile phone or a Bluetooth headset) close to a user's head may lead to health concerns, such as brain cancer. The carrying case of the present invention enables the user to keep the high frequency transmitter of the mobile phone away from the user's head.

Fourth, the carrying case of the present invention represents an improvement over wireless Bluetooth headsets because the carrying case eliminates the need to performing “pairing” of the headset. Rather, the retractable headset is directly connected to the stereo headphone jack of the mobile device through the interface cable.

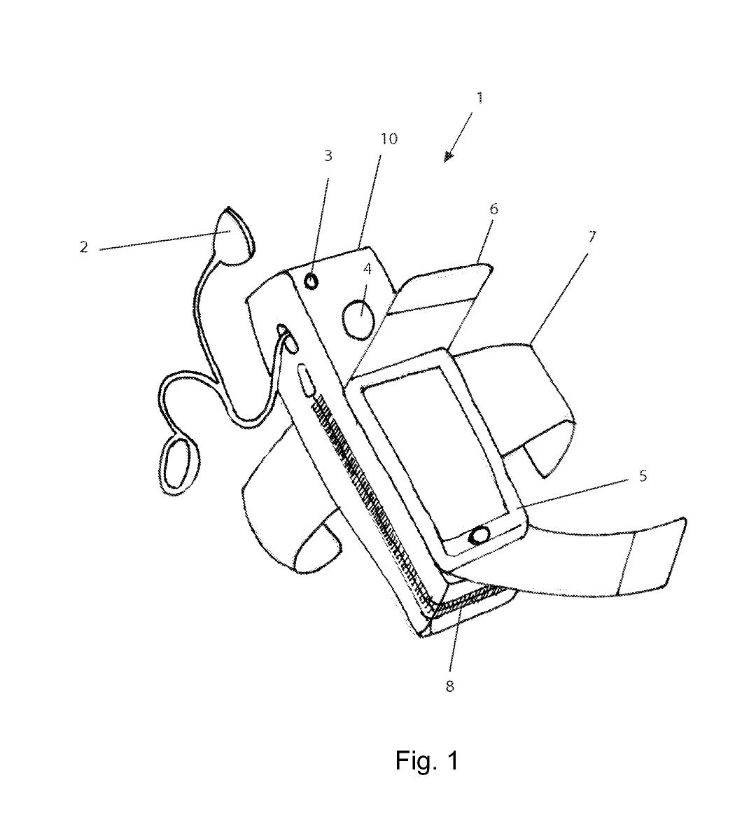

FIG. 1 is a perspective view of a multi-function mobile phone carrying case according to one embodiment of the present invention. Referring to FIG. 1, a multi-function mobile device carrying case 1 (“carrying case”) includes a case housing 10 including a retractable headset 2, a microphone 3, a control button 4 and an interface cable (not shown) integrated therein. In one embodiment, the case housing 10 is formed using fabric. In other embodiments, the case housing 10 may be formed using other suitable materials, such as silicone, or plastic. Furthermore, in embodiments of the present invention, the retractable headset 2, the microphone 3 and the control button 4 are formed on a printed circuit (PC) board (not shown).

In one embodiment, the retractable headset 2 is a stereo headset with the retractable case assembly housed inside and integrated with the carrying case 1. In one embodiment, the retractable headset is a headset available from YC Cable, model number R-AUDIO-4-BK. The microphone 3 is positioned in an opening in the case housing 10 to ensure no obstruction to sound reception. In some embodiments, the microphone is utilized to receive the user's voice during conversations and/or the user's voice commands needed to utilize the voice control function of the mobile device. In other embodiments, the microphone can also be used for recording voice memos.

In one embodiment, the control button 4 is a tactile button formed beneath the front cover of the case housing 10. Furthermore, in one embodiment, the control button 4 is formed using a rubberized tactile material to allow the control button to be actuated by feel, allowing the user to control the mobile device without looking at the mobile device.

The carrying case 1 further includes a device housing 5 for accommodating a mobile device (not shown). An interface cable (not shown) electrically connects the headset, the microphone and the control button of the carrying case 1 to the mobile device to be housed in the device housing 5. In some embodiments, the device housing 5 is a silicone case. Furthermore, in some embodiments, the device housing 5 is removably attached to the carrying case 1 to allow the mobile device housed therein to be easily and readily removed from the carrying case when desired. In one embodiment, the device housing 5 is attached to the carrying case 1 using Velcro.

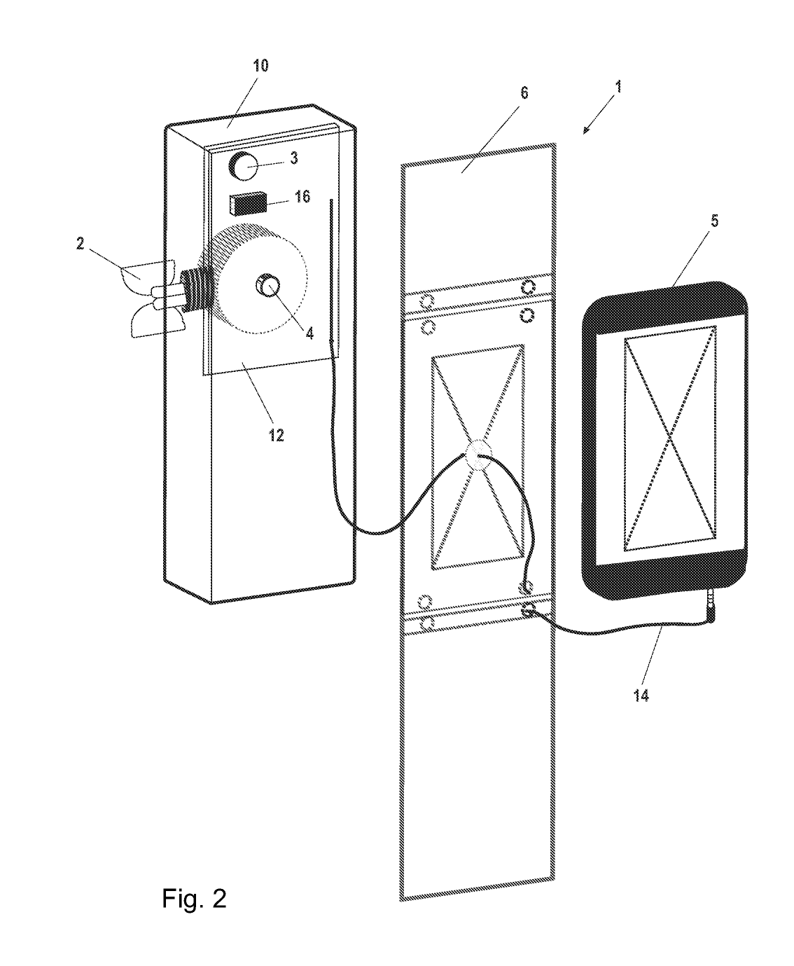

In the present embodiment, a protective cover assembly 6 is included having flaps extending out of the top and the bottom of the device housing 5 to cover and protect the front of the mobile device. In some embodiments, the protective cover assembly 6 is an elongated piece secured to the carrying case 1 and placed under the device housing 5 with flaps extending out of the top and bottom of the device housing, as illustrated in FIG. 2. In some embodiments, the device housing 5 is removably attached to the protective cover assembly 6 to allow the mobile device to be easily removed from the carrying case. In one embodiment, the device housing 5 is attached to the protective cover assembly 6 using Velcro.

Furthermore, an attachment assembly 7 may be attached to the back of the case housing 10 to allow the carrying case to be attached to external objects or to the user. The protective cover assembly 6 and the attachment assembly 7 are optional and may be omitted in other embodiments of the present invention. Furthermore, in the present embodiment, the carrying case 1 includes a zipper access 8 to the internal compartment of the case housing 10. The use of a zipper access is illustrative only. In other embodiments, other means for providing closure of the case housing may be used.

FIG. 2 is an exploded view of the multi-function mobile device carrying case showing the internal construction of the carrying case according to one embodiment of the present invention. Referring to FIG. 2, in the present embodiment, carrying case 1 includes a case housing 10, a protective cover assembly 6 attached to a front side of the case housing 10, and a device housing 5 attached to a front side of the protective cover assembly 6. The protective cover assembly 6 is optional and may be omitted in other embodiments of the present invention.

In the present embodiment, the case housing 10 of the carrying case 1 includes a PC board 12 with the microphone 3 and the control button 4 formed on an inner surface of the front side of the carrying case. Furthermore, in the present embodiment, the retractable headset 2 is attached to the backside of PC board 12 as shown by the dotted line in FIG. 2. The PC board 12 is attached to the inner surface of the front side of case housing 10 using various attachment methods, such as by sewing to the case housing 10. In other embodiments, the PC board 12 may be attached other inner surfaces of the carrying case.

The interface cable 14 has one end connected to the PC board 12 and electrically connected to the headset 2, the microphone 3 and the control button 4. The other end of the interface cable 14 includes a plug for plugging into the headphone jack of the mobile device. In the present embodiment, the interface cable 14 is threaded through holes in the protective cover assembly 6 to extend to the device housing. An opening in the device housing allows the interface cable 14 to reach the mobile device to be installed. In one embodiment, the interface cable 14 is a 4-wire cable including one wire for the left speaker, one wire for the right speaker, one wire for the microphone and one wire for the ground connection.

In the present embodiment, the interface cable 14 is threaded to the bottom side of the device housing 5. Therefore, the mobile device should be placed in the device housing with the headphone jack downwards to allow the plug of the interface cable 14 to be inserted into the jack. In other embodiments, the interface cable 14 may be threaded to the other sides of the device housing 5. The exact location where the interface cable 14 is threaded is not critical to the practice of the present invention as long as the interface cable can reach the headphone jack of the mobile device to be placed in the device housing 5.

In the present embodiment, the carrying case 1 further includes an audio jack 16 formed on the PC board 12. Audio jack 16 allows an auxiliary audio plug to be inserted into the carrying case to provide audio input function using an auxiliary device in place of using the retractable headset. For example, the audio jack 16 can be connected through the auxiliary audio plug to external speakers.

One of ordinary skill in the art, upon being appraised of the present invention, would appreciate that the multi-function mobile device carrying case can provide ease and convenient for the user to operate a mobile device. The user may be listening to music and when desired, the user may use the control button on the carrying case to make a phone call, such as through the use of the voice control function of the mobile device. When the user finishes with the phone call, the user may return to listening to music and the user may use the control button of the carrying case to skip forward to the next song or rewind backward to a previous song if desired. The user may perform all these functions without touching the mobile device, instead the user perform these functions through the multi-function capability realized by the carrying case. Furthermore, the carrying case of the present invention enables the user to use the mobile device in a hands-free manner.

The above detailed descriptions are provided to illustrate specific embodiments of the present invention and are not intended to be limiting. Numerous modifications and variations within the scope of the present invention are possible.

I claim:

1. A mobile device carrying case comprising:
a case housing comprising a retractable headset, a microphone, a control button and an interface cable integrated therein; and
a device housing attached to the case housing and configured to accommodate a mobile device,
wherein the interface cable is electrically connected to the retractable headset, the microphone, the control button and the interface cable is to be electrically connected to a headphone jack of a mobile device to be housed in the device housing, the carrying case providing audio, microphone and control functions for the mobile device through the interface cable.

2. The mobile device carrying case of claim 1, wherein the retractable headset, the microphone, the control button and a first end of the interface cable are formed on a printed circuit board integrated in the case housing.

3. The mobile device carrying case of claim 2, wherein the retractable headset is formed on a first side of the printed circuit board while the microphone and the control button are formed on a second side, opposite the first side, of the printed circuit board.

4. The mobile device carrying case of claim 1, wherein interface cable comprises a 4-wire cable including a wire for a left speaker, a wire for a right speaker, a wire for the microphone and a ground wire.

5. The mobile device carrying case of claim 1, wherein the device housing is removably attached to the case housing.

6. The mobile device carrying case of claim 1, further comprising a protective cover assembly formed at least above or below the device housing for covering a front side of the device housing.

7. The mobile device carrying case of claim 1, further comprising an attachment assembly attached to a backside of the case housing and configured to enable the carrying case to be attached to an external object.

8. The mobile device carrying case of claim 1, wherein the case housing further comprises an audio jack configured to accept an audio plug.

9. The mobile device carrying case of claim 1, wherein the control button provides at least voice control function for the mobile device.

10. The mobile device carrying case of claim 1, wherein the case housing is made from a material selected from the group of fabric, silicone, and plastic.
